(19) United States
(12) Patent Application Publication
(10) Pub. No.: US 2026/0139138 A1
(43) Pub. Date: May 21, 2026

(54) HIGHLY ELASTIC ASPHALT BINDERS FOR COLD REGION PAVEMENT APPLICATIONS

(71) Applicant: Rowan University, Glassboro, NJ (US)

(72) Inventors: Ayman Ali, Sewell, NJ (US); Yusuf Mehta, Turnersville, NJ (US); Goli Arunkumar, Glassboro, NJ (US)

(21) Appl. No.: 19/396,129

(22) Filed: Nov. 20, 2025

Related U.S. Application Data
(60) Provisional application No. 63/723,058, filed on Nov. 20, 2024.

(51) Int. Cl. C08L 95/00; E01C 7/26

(52) U.S. Cl. CPC C08L 95/00; E01C 7/265; C08L 2207/322; C08L 2555/22; C08L 2555/54; C08L 2555/64; C08L 2555/84

(57) ABSTRACT

In some implementations, an asphalt binder may include a base asphalt binder material, along with a styrene butadiene styrene polymer, which is present in an amount of at least about 7% by weight of the base asphalt binder material. The asphalt binder may also include a softening agent, which is present in an amount of at least about 7% by weight of the base asphalt binder material.

### CROSS-REFERENCE TO RELATED APPLICATIONS

This application claims the benefit of U.S. Provisional Application No. 63/723,058, filed on Nov. 20, 2024, which is hereby incorporated in its entirety.

### STATEMENT OF GOVERNMENT INTEREST

The invention was made with government support under Grant No. W913E518C0008 awarded by the Engineer Research and Development Center (ERDC). The government has certain rights in the invention.

### FIELD OF THE INVENTION

The present invention relates generally to asphalt mixtures for use in pavement applications, and more specifically to asphalt binders that are highly elastic relative to conventional asphalt binders, and that are therefore well suited to resisting cracking, particularly in heavy traffic load and extreme low temperature pavement applications.

### DISCUSSION OF RELATED ART

It is common in the roadway paving industry to use asphalt concrete material in constructing flexible pavement. Asphalt concrete material is generally formed by mixing crushed aggregate (e.g., stone) with an asphalt binder material that acts to bind/bond/hold the aggregate together. Generally, asphalt binder material is produced as part of a petroleum refining system (used to produce gasoline, diesel fuel, etc.). The asphalt binder is generally produced from residuum material that remains after distillation of petroleum to remove fuels and lubricants.

As is well-known, certain asphalt pavements are highly susceptible to various distresses such as rutting, cracking, and moisture damage etc., depending on the traffic and weather conditions of the region. Material properties of the asphalt binder material must be carefully controlled to avoid these issues and demonstrate satisfactory asphalt performance. For example, inadequate asphalt binder material properties may result in stiffness/brittleness and resulting pavement cracking at low environmental temperatures, and fluidity/softness resulting in pavement rutting at high temperatures. In some circumstances, small amounts of additives are sometimes blended into the asphalt binder to produce a modified binder material (in a wet mixing process), to achieve certain performance objectives. In some cases, dry additives are first blended with aggregates followed by addition of asphalt binder (in a dry mixing process).

The asphalt industry and/or research community have been working to develop alternative approaches for improving the performance of asphalt binders for a wide variety of pavement applications. This includes the use of special binders necessary for airfield pavements, highways with heavy traffic, slow moving traffic, pavements for use in relatively hot and relatively cold regions, etc. A particular selection of a type of polymer dosage or any other additive is typically made according to the local traffic and environmental connections for a desired application.

Suitable binders for a particular region are identified based on two criteria: (1) how the binder performs under an average seven-day maximum pavement temperature (C), and (2) how the binder performs under a minimum pavement design temperature likely to be experienced (C). The first criteria (the “high temperature” or “high PG” for the binder) appears as the first number in a PG binder label. The second criteria (the “low temperature” or “low PG” for the binder) appears as the second number in the PG binder label. For example, a PG 58-40 binder is intended for use where the average seven-day maximum pavement temperature is +58° C. and the expected minimum pavement temperature is −40° C.

Currently, asphalt binder development is typically focused on producing high polymer modified asphalt binders for high temperature asphalt applications (e.g., high PG ranging from +64° C. to +82° C.). For example, asphalt practitioners use various polymers, including SBS, and rejuvenators to produce asphalt binders that possess resistance against rutting and fatigue cracking in hot and tropical climate regions. In addition, softening agents were incorporated into these conventional binders for cold regions. When these conventional methods are used to produce binders for use in cold regions, they rely upon a typical polymer content (less than 5% by weight of asphalt binder) and a few softening agents (6-8% by weight of asphalt binders) that include aromatic oils or paraffinic oils. Because such binders include inadequate dosages of polymers or softening agents, they are typically limited to areas that do not experience extremely low temperatures.

In contrast, asphalt binders that are recommended by United Facilities Guide Specifications (UFGS) for extremely cold regions (based on design freezing index) include a high PG ranging from +52° C. to +58° C., and a low PG ranging from −34° C. to −40° C. In other words, using the PG nomenclature, the PG binders for cold regions range between PG 52-34 through PG 58-40.

Use of conventionally-produced asphalt binders in cold regions such as Alaska (e.g., low PG ranging from −34° C. to −40° C.) may exhibit slightly improved high and low temperature grades but do not successfully mitigate load-associated fatigue cracking and non-load associated low temperature cracking. In short, no existing technologies have utilized the approach of the present invention to reduce the asphalt binder's stiffness and improve the asphalt binder's performance grades by specifically focusing on low-temperature cracking that occurs in extremely cold regions, such as Alaska.

Embodiments of the present invention address these concerns by utilizing a composite modification approach that introduces softening agents into polymer-modified asphalt binders to produce a highly-elastic asphalt binder, which is designed to exhibit superior performance against cracking in cold environments (e.g., low PG ranging from −28° C. to −46° C.).

### SUMMARY OF THE INVENTION

According to certain embodiments of the present invention, an asphalt binder that possesses superior cracking performance in heavy traffic loads and/or extremely low temperatures is provided, as well as a method of making thereof.

In one general aspect, an asphalt binder may include a base asphalt binder material. The asphalt binder may also include a styrene butadiene styrene polymer, which is present in an amount of at least about 7% by weight of the base asphalt binder material. The asphalt binder may furthermore include a softening agent, which is present in an amount of at least about 7% by weight of the base asphalt binder material.

Implementations may include one or more of the following features. The asphalt binder may include sulfur, which is present in an amount of about 0.1% by weight of base asphalt binder material. The softening agent properties may include at least one of a viscosity between 10-100 cSt; a density between 0.85-0.93 g/cm³; or a flash point between 150-250° C. The softening agent may be corn oil or hydrolene oil. The asphalt binder may meet or exceed the performance targets for standard Asphalt Binder Grade PG 58-40. The asphalt mixture may comprise an aggregate and the asphalt binder. A pavement layer may be formed using the asphalt mixture.

In one general aspect, the method may include heating a base asphalt binder material to a shear temperature. The method may also include blending added styrene butadiene styrene polymer into the heated base asphalt binder material at a first shear speed for a first period of time. The method may furthermore include blending added sulfur into the blended styrene butadiene styrene polymer and heated base asphalt binder material mixture at a second shear speed for a second period of time, the second shear speed being lower than the first shear speed. The method may in addition include blending added softening agent into the blended sulfur, styrene butadiene styrene polymer, and heated base asphalt binder material mixture for a third period of time.

Implementations may include one or more of the following features. The shear temperature may be approximately 180-190° C. The first shear speed may be at least 3000 rpm. The first period of time may be at least 1 hour. Sulfur may be added in an amount of about 0.1% by weight of base asphalt binder material. The second shear speed may be about 600 rpm. The second period of time may be at least 3 hours. The softening agent may be added in an amount of at least about 7% by weight of the base asphalt binder. The third shear speed may be about 600 rpm. The third period of time may be at least 30 minutes. The prepared asphalt binder may meet or exceed the performance targets for standard Asphalt Binder Grade PG 58-40. The softening agent may be corn oil or hydrolene oil.

In one general aspect, the method may include heating a base asphalt binder material to a shear temperature. The method may also include blending added styrene butadiene styrene polymer into the heated base asphalt binder material at a first shear speed for a first period of time. The method may furthermore include blending added sulfur into the blended styrene butadiene styrene polymer and heated base asphalt binder material mixture at a second shear speed for a second period of time, the second shear speed being lower than the first shear speed. The method may in addition include blending added corn oil in an amount of at least about 7% by weight of the base asphalt binder into the blended sulfur, styrene butadiene styrene polymer, and heated base binder mixture for a third period of time.

### BRIEF DESCRIPTION OF THE FIGURES

An understanding of the following description will be facilitated by reference to the attached drawings, in which:

FIG. 1 is a chart showing the Jₙᵣ and percent recovery values for a plurality of exemplary binder materials at an 85-minute aging level, to show the effect of SBS and softening agents on changes in Jₙᵣ and percent recovery values for a plurality of exemplary binder materials.

FIG. 2 is a chart showing respective changes in cracking temperatures for a plurality of exemplary binder materials at a 20-hour aging level, to show the effect of SBS and softening agents on changes in cracking temperatures for a plurality of exemplary binder materials.

FIG. 3 is a chart showing respective Glover-Rowe (G-R) parameters obtained for several exemplary binder materials at a 20-hours aging level, to show the effect of SBS and softening agents on changes in Glover-Rowe (G-R) parameter results for a plurality of exemplary binder materials.

FIG. 4 is a chart showing respective thermal strains observed for several exemplary 20-hours aging level binder materials at low temperatures, to show the effect of SBS and softening agents on changes in thermal strain results for a plurality of exemplary binder materials.

FIG. 5 is a chart showing respective Asphalt Binder Cracking Device (ABCD) test parameters obtained for several exemplary binder materials at a 20-hours aging level, to show the effect of SBS and softening agents on changes in ABCD test results, such as critical temperature and fracture energies for a plurality of exemplary binder materials.

### DETAILED DESCRIPTION

Embodiments of the present invention describe a highly-elastic asphalt binder (HEB) better suited to avoiding rutting, cracking, etc. in heavy traffic load and extreme low temperature pavement applications. The HEB described herein have enhanced aging characteristics and cracking resistance at intermediate and low temperatures.

The present invention provides for production of highly elastic asphalt binders using SBS as a modifier and corn oil as a softening agent (SA), by blending the SBS and corn oil into conventional asphalt binder material.

An HEB in accordance with the present invention may be used to the potential risk of thermal cracking in asphalt pavements, which is a particular concern in cold temperature regions. The HEB can outperform, at low temperatures, conventional binders while maintaining similar performance at high temperatures. Utilizing a composite modification approach to produce an asphalt binder recipe focusing on cold regions is a unique approach.

According to certain embodiments, the HEB may include a styrene butadiene styrene (SBS) polymer, which has a chemically different structure than the polymers used in conventional asphalt binders. This difference in structure allows the use of a higher dosage than is present in conventional asphalt binders (typically less than 5% by weight of asphalt binder). Suitable amounts of SBS content for the HEB may include but are not limited to ranges of: less than 7%, 7%, 7-8%, 7-7.5%, 7.5%, 7.5-8%, 8%, and greater than 8% by weight of the base asphalt binder.

The HEB may further include sulfur. Sulfur may react with the unsaturated butadiene segments in SBS, forming polysulfide bridges that enhance the rigidity and elasticity of the polymer network. In other words, the sulfur acts as a crosslinking agent between the base binder and the SBS. Suitable amounts of sulfur content for the HEB may include but are not limited to ranges of: less than 0.1%, about 0.1%, and greater than 0.1% by weight of the base asphalt binder.

The HEB may further include a softening agent (SA). The SA may reduce the fragility of the asphalt binders at low temperatures because the lighter components in the SA diffuse into the polymer network and cause the polymer to swell. According to certain embodiments of the present invention, suitable SA materials include but are not limited to corn oil (and/or other triglyceride-based vegetable oils), hydrolene oil, bio-oil, tallow oil, waste cooking oil, aromatic extracts, paraffinic oils, etc. Moreover, suitable SA materials may include any material comprising one or more of the properties listed in Table 2 below. Such properties may be selected based on correlation to superior performance of the resulting asphalt binder, such as High and Low Temperature Performance Grade (PG), Multiple Stress Creep Recovery, Linear Amplitude Sweep (LAS) Test, Glover Rowe (G-R) Parameter, Bending Beam Rheometer (BBR), ΔTc, among other suitable performance properties.

Suitable amounts of SA content for asphalt binders may include but are not limited to ranges of: less than 5%, 5-6%, 5-7%, 5-8%, 5-9%, 5-10%, 5-11%, 5-12%, 5-13%, 5-14%, 5-15%, 6%, 6-7%, 6-8%, 6-9%, 6-10%, 6-11%, 6-12%, 6-13%, 6-14%, 6-15%, 7%, 7-8%, 7-9%, 7-10%, 7-11%, 7-12%, 7-13%, 7-14%, 7-15%, 8%, 8-9%, 8-10%, 8-11%, 8-12%, 8-13%, 8-14%, 8-15%, 9%, 9-10%, 9-11%, 9-12%, 9-13%, 9-14%, 9-15%, 10%, 10-11%, 10-12%, 10-13%, 10-14%, 10-15%, 11%, 11-12%, 11-13%, 11-14%, 11-15%, 12%, 12-13%, 12-14%, 12-15%, 13%, 13-14%, 13-15%, 14%, 14-15%, 15%, and greater than 15% by weight of the base asphalt binder.

Table 1 below shows that use of SAs provides a greater improvement in the low temperature grade of the SBS modified binders. Furthermore, the results in Table 1 show that the best combination leading to most improvement in both high and low temperature grades of the base binder was that containing 7.5% SBS and 7% Corn Oil. Nevertheless, SAs had lowered the low temperature grade for all the SBS modified binders. This suggests that SAs can aid in improving the low temperature grade as well as mitigate the effects of aging. Therefore, it can be concluded that SAs are useful for improving the low temperature grades of neat and modified soft asphalt binders.

TABLE 1

| | High PG_{cont.} | | True | Low PG_{cont.} (PAV 20) | | True | Performance |
|---|---|---|---|---|---|---|---|
| Binder ID | Org. | RTFO | High PG | S | m | Low PG | Grade (PG) |
| PG 52-28 Base | 53 | 52.8 | 52.8 | −32.1 | −33.3 | −32.1 | PG 52-28 |
| 7.5% SBS | 72.9 | 72.1 | 72.1 | −34.5 | −35.9 | −34.5 | PG 70-34 |
| 7.5% SBS + 7% CO | 60.3 | 58.7 | 58.7 | −48.4 | −43.9 | −43.9 | PG 58-40 |
| 7.5% SBS + 7% HO | 63.0 | 61.7 | 61.7 | −41.0 | −41.9 | −41 | PG 58-40 |
| 7.5% SBS + 14% CO | 48.6 | 49.2 | 48.6 | −49.0 | −51.9 | −49 | PG 46-46 |
| 7.5% SBS + 14% HO | 54.8 | 53.5 | 53.5 | −45.9 | −45.2 | −45.2 | PG 52-40 |

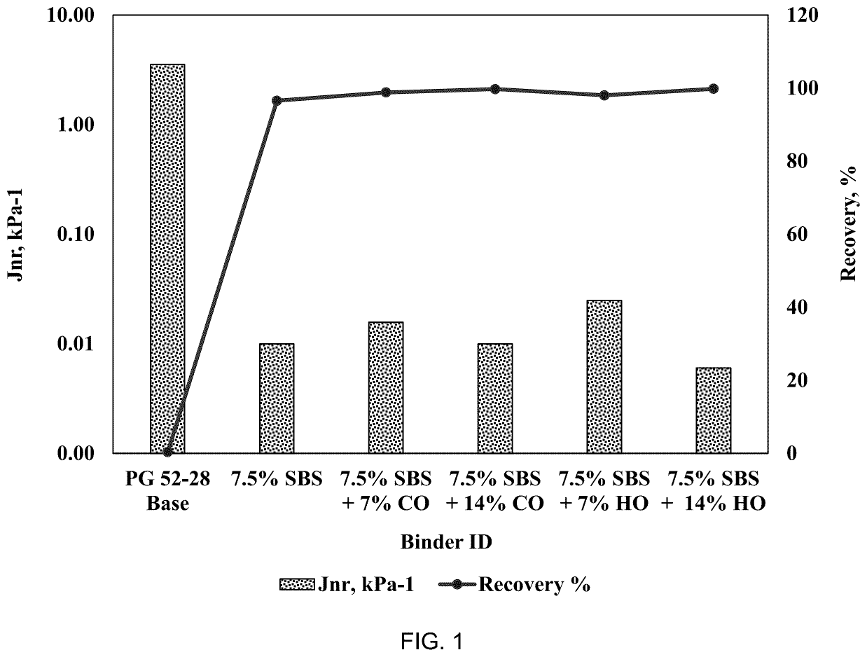

FIG. 1 shows the Non-Recoverable Creep Compliance (Jₙᵣ) and percent recovery results of several exemplary binder materials at RTFO aging level tested for Multiple Stress Creep and recovery (MSCR) test. The impact of high polymer content (7.5% SBS) is evident by a reduction of Jₙᵣ and enhanced recovery properties. Inclusion of softening agents still hold enhanced rut resistance. The Jₙᵣ values are nearly zero (0.01 kPa⁻¹) and percent recovery is nearly 100% at 3.2 kPa stress level. The same pattern can be observed for all the HEBs indicating their rut potential compared to the control binders.

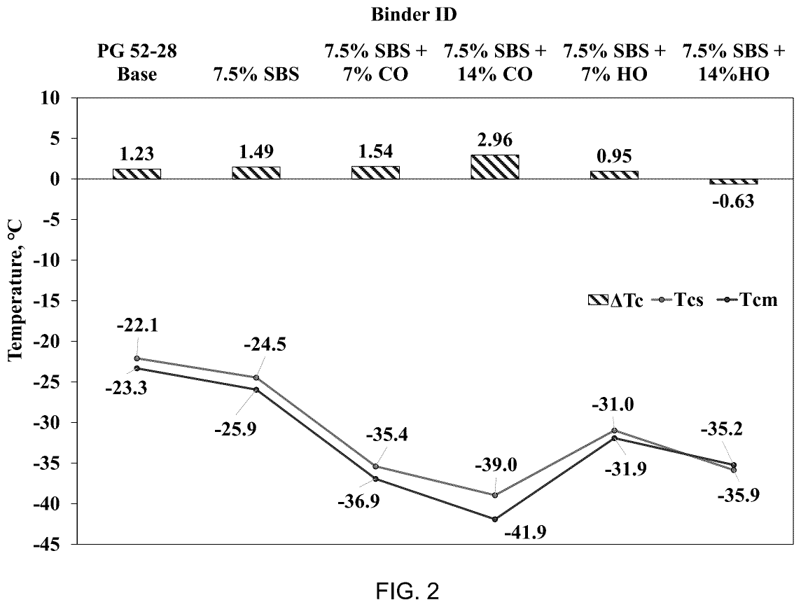

FIG. 2 illustrates the change in cracking temperature (T_{cs}, Tₑₘ, and ΔTc) values measured for the 20-hour PAV aged neat and modified binders prepared with and without SAs. Notably, the highly polymer-modified binder (7.5% SBS polymer) did not significantly improve the failure temperatures. However, by comparing the T_{cs}, T_{cm}, values for the combinations containing only SBS to those containing both SBS and corn oil/hydrolene oil, it can be seen from FIG. 2 that the addition of corn oil and hydrolene oil helps increase the ΔTc as well as critical failure temperature values. These results demonstrate that corn oil and hydrolene oil can help modified binders in improving the ability of resistance to both cracking at long term aging level.

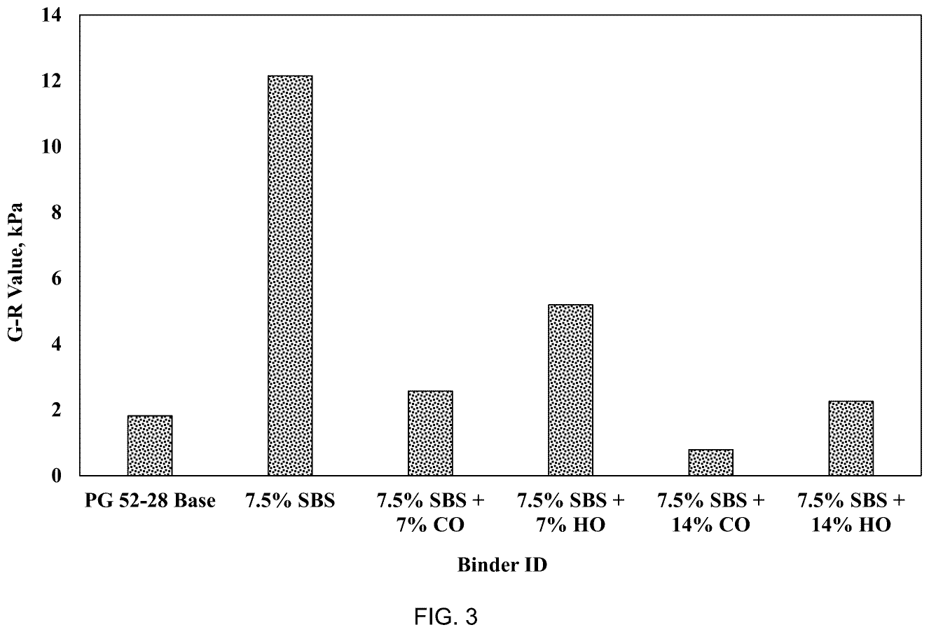

FIG. 3 presents the Glover-Rowe (G-R) parameter obtained for several exemplary binder materials at a 20-hours PAV aging level. G-R is a surrogate ductility parameter that relates to the storage modulus, G′=G*cos(δ), and the dynamic viscosity (η′). The G-R value is usually an indicator of the impact of aging on cracking resistance of binders. Specifically, a G-R value of 180 kPa corresponds to the onset of non-load associated cracking, while a G-R value of 600 kPa or greater represents significant cracking issues. From FIG. 3, it can be seen that SAs reduced G-R values. This means that addition of softening agents can improve the binders' cracking properties. FIG. 3 also shows that the inclusion of SBS in the binders increased G-R values, which does not suggest that SBS reduced cracking resistance of binders, as SBS improved cracking resistance. It is worth noting that while the G-R parameter can help assess the impact of aging on the properties of asphalt binders it is not suitable to evaluate the effect of polymers on cracking resistance.

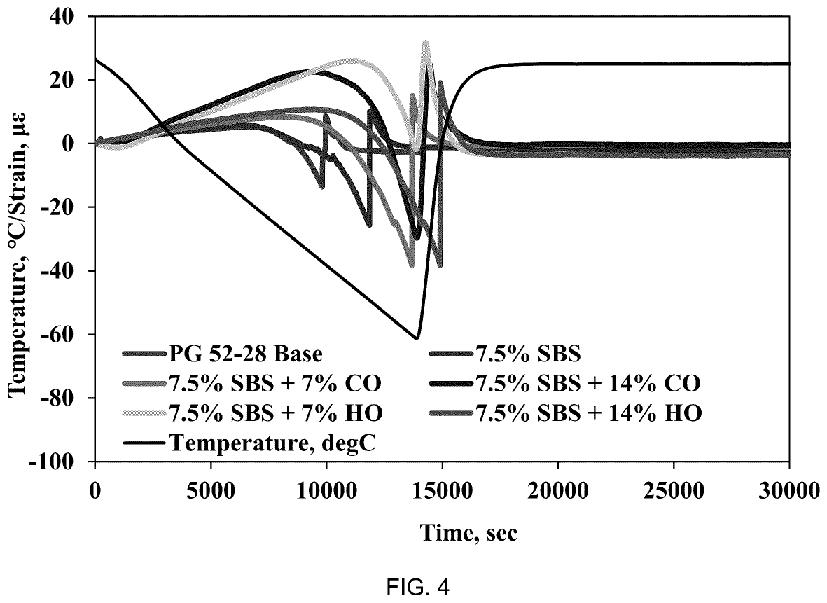

FIG. 4 illustrates thermal strains developed in several exemplary binder materials at a 20-hours PAV aging level. The thermal strains increased with reduction in temperature and recovery, as the binder reached failure during the asphalt binder cracking device (ABCD) test. It can be noticed that with the addition of SBS polymer and softening agents, HEBs reached fracture at lower temperatures indicating the potential of HEBs holding thermal strain at extremely low temperatures, as compared to control binders. When the binder reached failure and cracks, a strain jump was observed in FIG. 4 (defined as a critical temperature).

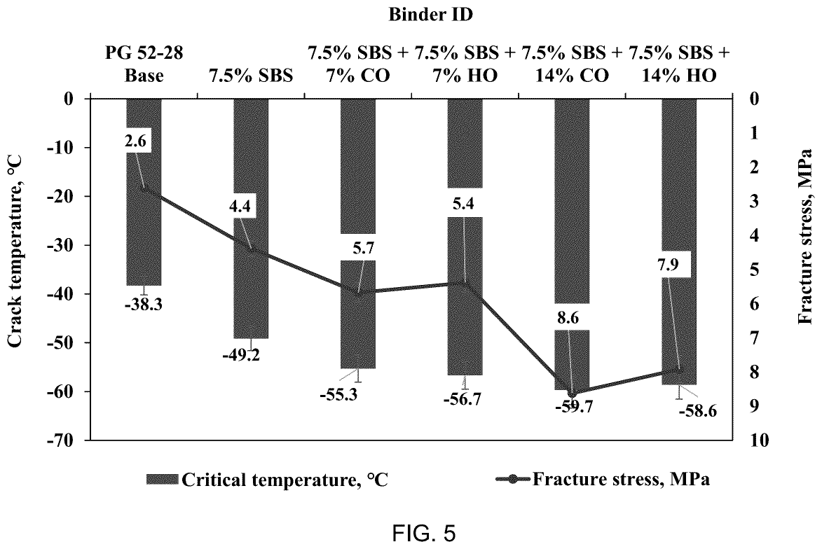

FIG. 5 presents critical temperature and fracture stress results of exemplary binders (the data presented is based on PG 52-28, although other exemplary binders were tested, such as PG 46-46 and PG 64-22) at a 20-hour PAV aging level. A lower critical temperature and higher fracture stress resembles the ability of asphalt binders to withhold the thermal stresses at low temperatures. As expected, HEBs improved the ABCD critical temperatures and fracture stresses. Comparing HEBs with the 7.5% SBS binder, the critical temperatures reduced significantly, suggesting the presence of SBS polymer and softening agents played a role in resisting thermal stresses at extremely low temperatures in cold regions.

For example, the present invention provides asphalt binders that can resist low temperature cracking up to −46° C. (PG 46-46). As noted above, PG 46-46 is one of the binders tested that performed well until −46° C. The HEB binders for low temperature applications range from PG 58-40 (on the milder end of cold climate applications) to PG 46-46 (on the more extreme end of cold climate applications). For purposes of the inventive binder, the testing and requirements include binders at the milder end (PG 58-40) and the extreme end (PG 46-46) and can extend further as additional testing and/or development is done to expand the binder PG range for extremely cold climate applications.

As one exemplary embodiment, a binder formulation that included 7.5% SBS and 7% SA was found to significantly improve the cracking performance when compared to conventional binders used in extremely cold regions. In this exemplary embodiment, corn oil was selected as the SA, although any SA meeting the described attributes in Table 2 and FIGS. 1-5 may be used to achieve the desired HEB. During testing, this binder combination demonstrated the most improvement in both high and low temperature grades. That being said, the dosages of polymer and/or softening agents may vary with source and grade of base binder.

As described above, the approach of using high polymer modification along with the addition of softening agents can significantly enhance both the rutting, fatigue cracking, and thermal cracking resistance of asphalt binders. Asphalt mixtures prepared using HEBs were found to lead to the best improvement in durability, rutting, and short-term low temperature cracking performance.

It should be noted that the exemplary observations disclosed herein may vary with the source of asphalt binder. In accordance with the present invention, the base asphalt binder is PG 52-28, whereas the formulation may vary if the base binder is changed to any other performance grade (PG). For example, in the case where base binder from any other source is a stiffer binder, production of HEBs can demand less SBS and SA. In addition, the other possible variation to be considered in this study is the specific products used to produce HEBs. In certain experiments, the polymer was SBS D0243 ET and the softening agent was POET JIVE corn oil. That being said, the skilled person in the relevant art will understand that other SBS polymers and SAs can also be used as described above.

In accordance with certain embodiments of the present invention, the HEB is formed in a process, which involves blending the SBS and a SA together with a neat, unmodified asphalt binder. Certain embodiments may further include the addition of sulfur to the mixture.

The blending process of highly elastic asphalt binders using a composite approach involves mixing the base binder, SBS, softening agent, and sulfur in different shear speeds. In one example, the base asphalt binder shall be heated to mixing temperature (between 180-190° C.) and then SBS polymer shall be added into the binder and blended for a period of 1 hour at high shear speed of 3000 rpm and blending temperature (between 180-190° C.). This process continues until no solid particles are visibly present in the mix. After 1 hour, sulfur shall be added gradually at 0.1% by weight of base binder to the SBS-binder blend and continuously mixed for 3 hours using the low shear mixer at 600 rpm and temperature between 180-190° C. Sulfur serves as a cross-linking agent to help minimize separation between the base binder and SBS. The SA may then be added into the blend and mixed for a period of 30 minutes at a speed of 600 rpm. The temperature throughout the process is maintained at a temperature of between 180-190° C.

### EXAMPLE

The following example is provided for illustrative purposes only and is not intended to limit the scope of the invention. In accordance with one aspect of the present invention, a method of preparing an HEB is provided. By way of example, this method may be performed by an asphalt designer and/or a manufacturer/contractor.

Step 1: Binder material selection. In this exemplary method, the binder materials include a base asphalt binder, SBS, sulfur, and a suitable SA. The selection of a suitable SA may be based on the criteria discussed above. The skilled person will understand that such performance properties may evolve based on changes and/or improvements to the testing equipment and/or methodology. In the present example, Table 2 below includes a list of SA properties that have been developed for selection of a suitable SA.

TABLE 2

| Property | Requirements | |
|---|---|---|
| Viscosity @ 40° C. | 10-100 | cSt |
| Density @ 25° C. | 0.85-0.93 | g/cm³ |
| Acid Value | ≤10 | mg KOH/g |
| Iodine Value | 0-130 g I₂/100 g | |
| Flash Point | 150-250° | C. |

Step 2: Heating and high shear speed blending of SBS with the base asphalt binder. In this exemplary step, the base asphalt binder was heated to a shear temperature between 180-190° C. The SBS polymer was then added to the heated base asphalt binder in an amount equal to 7.5% by weight of the base asphalt binder. The resulting mixture was then blended for a period of 1 hour at a high shear speed of 3000 rpm and a shear temperature between 180-190° C.

Step 3: Low shear speed blending of sulfur with SBS/base asphalt binder mixture. In this exemplary step, sulfur was gradually added to the mixture in an amount equal to 0.1% by weight of the base asphalt binder. The resulting mixture was then blended for a period of 3 hours at a low shear speed of 600 rpm and a shear temperature between 180-190° C. The residence time of 3 hours was selected to ensure sufficient cross-linking among the materials, as cross-linking helps minimize separation between the base binder and the SBS polymer.

Step 4: Low shear speed blending of SA with SBS/base asphalt binder/sulfur mixture. In this exemplary step, the SA (which in this exemplary embodiment was oil), was gradually added to the mixture in an amount equal to 7% by weight of the base asphalt binder. The resulting mixture was then blended for a period of 30 minutes at a low shear speed of 600 rpm and a shear temperature between 180-190° C.

In the present example, Table 3 below includes a list of performance properties of an asphalt binder prepared according to Steps 1-4 in this exemplary example. With respect to the PG targets, it is important to note that minimum criteria is PG 58-40 and then extends to PG 46-46 (or further). Thus, the requirement is that the HEB must meet at least the minimum target of PG 58-40.

TABLE 3

| | AASHTO | | Performance |
|---|---|---|---|
| Test/Property | Standard | Test Conditions | Targets |
| High and Low | AASHTO M332 | Derived from DSR | ≥PG 58-40 |
| Temperature | | and BBR tests | |
| Performance Grade (PG) | | | |
| Multiple Stress Creep | AASHTO T350 | 52° C., 3.2 kPa | Jₙᵣ ≤0.05 kPa⁻¹; |
| Recovery | | stress level | % R ≥95% |
| Linear Amplitude Sweep | AASHTO T391 | 4° C., ε = 5% | Fatigue life |
| (LAS) Test | | | (Nf) ≥500 cycles |
| Glover Rowe (G-R) | PAV20 aged | 15° C., 0.005 rad/s | G-R ≤7 kPa |
| Parameter | binder's master | | |
| | curve | | |
| Bending Beam | AASHTO T313 | Based on BBR | ΔTc <4° C. |
| Rheometer (BBR), ΔTc | | stiffness & m-value | |

In accordance with the present invention, high polymer contents and softening agent additives are used in asphalt binders as a new approach in asphalt binder applications, to provide highly-elastic asphalt binders. The highly-elastic asphalt binders have a unique formulation focusing on improved performance at cold temperatures. To date, only high polymer modified asphalt binders were used for high temperature regions. Binders with low performance grade of up to only −28° C. are being used by highway agencies. However, in accordance with the present invention, the softening agents were introduced to ensure the binders are relevant to low temperature regions. This approach can result in developing asphalt binders with a low performance grade up to −46° C.

Accordingly, the present invention provides highly elastic asphalt binders addressing the concern of asphalt cracking issues that are associated with conventional asphalt binders at low temperature regions. The highly elastic asphalt binders can be used to produce asphalt mixtures to help highway agencies mitigate low temperature cracking in asphalt pavement in low temperature regions.

It will be appreciated that the HEBs in accordance with the present invention would be beneficial to federal and state agencies for use in interstate highway construction. The HEB formulation provides guidance to commercially produce HEBs that can resist against load and non-load related cracking distresses in cold regions including the northern United States, Canada, and Alaska. Authorities such as the Federal Highway Administration (FHWA), Department of Defense, and United States Department of Transportation (USDOT) can implement construction of highway pavements at cold regions as these HEB binders sustain coupled effects of loads resisting thermal cracking phenomenon. Due to these benefits, an asphalt mixture prepared with a highly elastic binder in accordance with the present invention in at least partial substitution for conventional asphalt binder material provides a low-maintenance asphalt pavement structure impacting the cost and environmental footprint.

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. An asphalt binder comprising a blend of:
a base asphalt binder material;
a styrene butadiene styrene polymer, which is present in an amount of at least about 7% by weight of the base asphalt binder material; and
a softening agent, which is present in an amount of at least about 7% by weight of the base asphalt binder material.

2. The asphalt binder of claim 1, further comprising sulfur, which is present in an amount of about 0.1% by weight of base asphalt binder material.

3. The asphalt binder of claim 1, wherein properties of the softening agent comprise at least one of a viscosity between 10-100 cSt; a density between 0.85-0.93 g/cm³; or a flash point between 150-250° C.

4. The asphalt binder of claim 1, wherein the softening agent is corn oil or hydrolene oil.

5. The asphalt binder of claim 1, wherein the asphalt binder meets or exceeds performance targets for standard Asphalt Binder Grade PG 58-40.

6. An asphalt mixture comprising an aggregate and the asphalt binder of claim 1.

7. A pavement layer formed using the asphalt mixture of claim 6.

8. A method of preparing an asphalt binder, the method comprising:
heating a base asphalt binder material to a shear temperature;
blending added styrene butadiene styrene polymer into the heated base asphalt binder material at a first shear speed for a first period of time;
blending added sulfur into the blended styrene butadiene styrene polymer and heated base asphalt binder material mixture at a second shear speed for a second period of time, the second shear speed being lower than the first shear speed; and
blending added softening agent into the blended sulfur, styrene butadiene styrene polymer, and heated base asphalt binder material mixture for a third period of time.

9. The method of claim 8, wherein the shear temperature is approximately 180-190° C.

10. The method of claim 8, wherein the first shear speed is at least 3000 rpm.

11. The method of claim 10, wherein the first period of time is at least 1 hour.

12. The method of claim 8, wherein the sulfur is added in an amount of about 0.1% by weight of base asphalt binder material.

13. The method of claim 12, wherein the second shear speed is about 600 rpm.

14. The method of claim 13, wherein the second period of time is at least 3 hours.

15. The method of claim 8, wherein the softening agent is added in an amount of at least about 7% by weight of the base asphalt binder material.

16. The method of claim 15, wherein the third shear speed is about 600 rpm.

17. The method of claim 16, wherein the third period of time is at least 30 minutes.

18. The method of claim 8, wherein the prepared asphalt binder meets or exceeds performance targets for standard Asphalt Binder Grade PG 58-40.

19. The method of claim 8, wherein the softening agent is corn oil or hydrolene oil.

20. A method of preparing an asphalt binder, the method comprising:
heating a base asphalt binder material to a shear temperature;
blending added styrene butadiene styrene polymer into the heated base asphalt binder material at a first shear speed for a first period of time;
blending added sulfur into the blended styrene butadiene styrene polymer and heated base asphalt binder material mixture at a second shear speed for a second period of time, the second shear speed being lower than the first shear speed; and
blending added corn oil in an amount of at least about 7% by weight of the base asphalt binder material into the blended sulfur, styrene butadiene styrene polymer, and heated base binder material mixture for a third period of time.
